(19) United States
(12) Patent Application Publication
(10) Pub. No.: US 2005/0231455 A1
(43) Pub. Date: Oct. 20, 2005

(54) Display device and driving method thereof

(76) Inventor: Seung-Hwan Moon, Yongin-si (KR)

Correspondence Address: PATENT LAW GROUP LLP, 2635 NORTH FIRST STREET, SUITE 223, SAN JOSE, CA, 95134, US

(21) Appl. No.: 11/109,569

(22) Filed: Apr. 18, 2005

(30) Foreign Application Priority Data
Apr. 19, 2004 (KR) 10-2004-0026752

(51) Int. Cl. G09G 3/36

(52) U.S. Cl. 345/89

(57) ABSTRACT

A display device includes: pixel rows including pairs of first and second pixels arranged in turn in each row; first and second gate lines connected to the first and second pixels, respectively; and data lines intersecting the gate lines. Each data line is disposed in between a pair of first and second pixels and connected to the pixels. The pixels are charged by voltages from the data lines in response to signals from the gate lines. The first pixels finish the voltage charging before the voltage charging of the second pixels in the pixel row is finished. The second pixels have a precharging time before the first pixels finish the voltage charging and a main charging time after the first pixels finish the voltage charging. The polarities of voltages charged into the second pixels during the precharging time and the main charging time are the same.

### BACKGROUND OF THE INVENTION

(a) Field of the Invention

The present invention relates to a display device and a driving method thereof.

(b) Description of Related Art

An active type display device such as an active matrix (AM) liquid crystal display (LCD) and an active matrix organic light emitting display (OLED) includes a plurality of pixels arranged in a matrix and including switching elements and a plurality of signal lines such as gate lines and data lines for transmitting signals to the switching elements. The switching elements of the pixels selectively transmit data signals from the data lines to the pixels in response to gate signals from the gate lines for displaying images. The pixels of the LCD adjust transmittance of incident light depending on the data signals, while those of the OLED adjust luminance of light emission depending on the data signals.

The display device further includes a gate driver for generating and applying the gate signals to the gate lines and a data driver for applying the data signals to the data lines. Each of the gate driver and the data driver generally includes several driving integrated circuit (IC) chips. The number of the IC chips is preferably small to reduce manufacturing cost. In particular, limiting the number of the data driving IC chips is important since the data driving IC chips are much expensive than the gate driving IC chips.

### SUMMARY OF THE INVENTION

A display device is provided, which includes: a plurality of pixel rows, each pixel row including a plurality of pairs of first and the second pixels arranged in turn; a plurality of first signal lines connected to the first pixels; a plurality of second signal lines connected to the second pixels; and a plurality of third signal lines intersecting the first and the second signal lines, each of the third signal lines disposed in between a pair of first and second pixels and connected to the pair of the first and the second pixels. The first and the second pixels are charged by voltages from the third signal lines in response to signals from the first and the second signal lines, respectively.

The polarity of the voltages transmitted by each of the third signal lines may be constant during a frame and is opposite between two adjacent frames. The polarity of the voltages transmitted by adjacent third signal lines may be opposite.

According to an embodiment of the present invention, the first pixels in each pixel row finish the voltage charging earlier than the second pixels in the pixel row finish the voltage charging. The second pixels in each pixel row have a precharging time where charging voltages are applied before the charging of the first pixels in the pixel row is finished and a main charging time where charging voltages are applied after the charging of the first pixels in the pixel row is finished. The polarity of voltages charged into the second pixels during the precharging time is the same as the polarity of voltages charged into the second pixels during the main charging time.

The precharging time of the second pixels in each pixel row may overlap the charging time of the first pixels in the pixel row at least in part.

The first pixels in each pixel row may have a precharging time overlapping the main charging time of the second pixels in a previous row and a main charging time for charging voltages after the second pixels in the previous row finish the main charging. The polarity of voltages charged into the first pixels during the precharging time thereof may be to the same as the polarity of voltages charged into the first pixels during the main charging time thereof. Alternatively, the precharging time of the second pixels in each pixel row may be equal to the charging time of the first pixels in the pixel row.

The precharging time of the second pixels in each pixel row may be spaced apart from the charging time of the first pixels in the pixel row.

The first pixels in each pixel row may have a precharging time finishing before the precharging time of the second pixels in the pixel row and a main charging time between the precharging time of the second pixels in the pixel row and the main charging time of the second pixels in the pixel row. The polarity of voltages charged into the first pixels during the precharging time thereof may be the same as the polarity of voltages charged into the first pixels during the main charging time thereof.

According to another embodiment of the present invention, the charging time of the first pixels in each pixel row overlaps at least in part the charging time of the second pixels in the pixel row or the charging time of the first or the second pixels in another pixel row.

The charging time of the second pixels in each pixel row may overlap the charging time of the first pixels in the pixel row at least in part.

The first pixels in each pixel row may begin the voltage charging before the second pixels in a previous pixel row finish the voltage charging and continue the voltage charging after the second pixels in the previous pixel row finish the voltage charging. The second pixels in each pixel row may begin the voltage charging before the first pixels in the pixel row finish the voltage charging and continue the voltage charging after the first pixels in the pixel row finish the voltage charging. Alternatively, the second pixels in each pixel row may start the voltage charging in synchronization with the start of the voltage charging of the first pixels in the pixel row and continue after the completions of the voltage charging of the first pixels in the pixel row.

The charging time of the second pixels in each pixel row may partly overlap the charging time of the second pixels in a previous pixel row. The charging time of the first pixels in each pixel row may partly overlap the charging time of the first pixels in a previous pixel row. The charging time of the first pixels in each pixel row may be spaced apart from the charging time of the second pixels in the pixel row.

A method of driving a display device including a plurality of first and the second pixels that are alternately arranged in a plurality of pixel rows is provided, which includes: charging first voltages in the first pixels; charging second voltages into the second pixels before the charging of the first voltages is finished; and charging third voltages having a polarity the same as polarity of the second voltages into the second pixels after the charging of the first voltages is finished.

The charging of the second voltages and the charging of the third voltages may be sequentially performed, and the charging of the first voltages and the charging of the second voltages may be simultaneously performed.

The method may further include: charging the first pixels with fourth voltages having a polarity to the same as the polarity of the first voltages before the charging of the first voltages and the charging of the second voltages. The charging of the fourth voltages and the charging of the first voltages may be performed in sequence.

The charging of the second voltages may be finished before the charging of the first voltages starts. The method may further include: charging the first pixels with fourth voltages having a polarity the same as the polarity of the first voltages before the charging of the second voltages. The charging of the fourth voltages may be finished before the charging of the second voltages starts.

### BRIEF DESCRIPTION OF THE DRAWINGS

The present invention will become more apparent by describing embodiments thereof in detail with reference to the accompanying drawing in which:

FIG. 1 is a block diagram of an LCD according to an embodiment of the present invention;

FIG. 2 is an equivalent circuit diagram of a pixel of an LCD according to an embodiment of the present invention;

FIG. 3 illustrates an arrangement of the pixels and the signal lines according to an embodiment of the present invention;

FIG. 4 is a layout view of a lower panel according to an embodiment of the present invention;

FIGS. 5 and 6 are sectional views of the lower panel shown in FIG. 4 taken along the lines V-V′ and VI-VI′, respectively;

FIG. 7 shows polarity of the pixel voltages of the pixels having the arrangement shown in FIG. 3 under column inversion;

FIGS. 8A, 9A, 10A and 11A illustrate signal waveforms of LCDs according to embodiments of the present invention; and

FIGS. 8B, 9B, 10B and 11B illustrate polarity of the pixel voltages of a pixel row in the LCDs shown in FIGS. 8A, 9A, 10A and 11A as a function of time, respectively.

### DETAILED DESCRIPTION OF EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Like numerals refer to like elements throughout.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Then, liquid crystal displays as an example of display device according to embodiments of the present invention will be described with reference to the accompanying drawings.

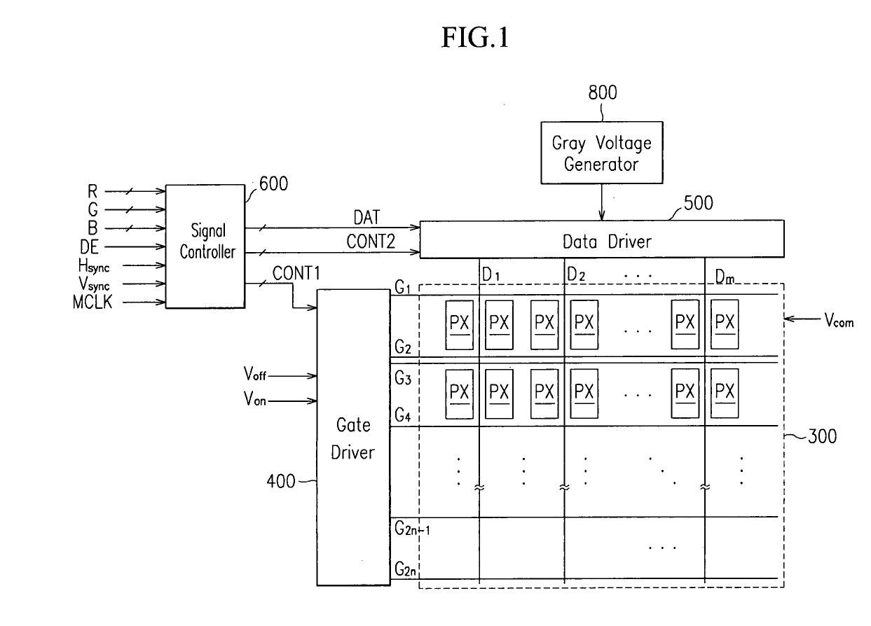

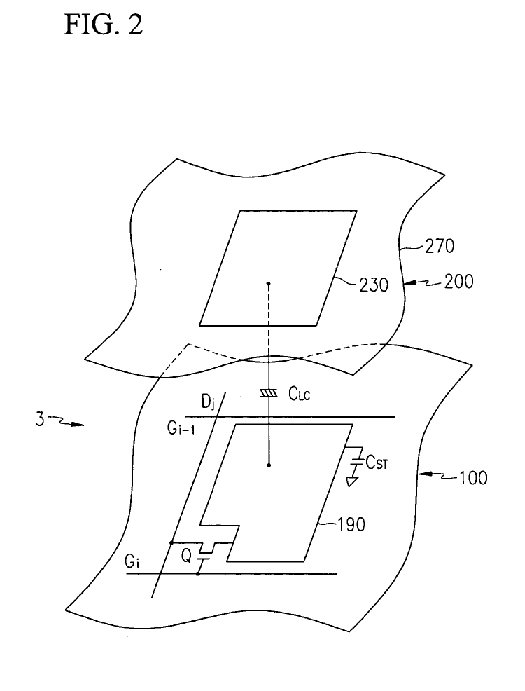

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment includes a LC panel assembly 300, a gate driver 400 and a data driver 500 that are connected to the panel assembly 300, a gray voltage generator 800 connected to the data driver 500, and a signal controller 600 controlling the above elements.

Referring to FIG. 1, the panel assembly 300 includes a plurality of display signal lines G₁-G₂ₙ and D₁-Dₘ and a plurality of pixels PX connected thereto and arranged substantially in a matrix. In a structural view shown in FIG. 2, the panel assembly 300 includes lower and upper panels 100 and 200 and a LC layer 3 interposed therebetween.

The display signal lines G₁-G₂ₙ and D₁-Dₘ are disposed on the lower panel 100 and include a plurality of gate lines G₁-G₂ₙ transmitting gate signals (also referred to as “scanning signals”), and a plurality of data lines D₁-Dₘ transmitting data signals. The gate lines G₁-G₂ₙ extend substantially in a row direction and substantially parallel to each other, while the data lines D₁-Dₘ extend substantially in a column direction and substantially parallel to each other.

Each pixel PX includes a switching element Q connected to the signal lines G₁-G₂ₙ and D₁-Dₘ, and a LC capacitor C_{LC} and a storage capacitor C_{ST} that are connected to the switching element Q. In other embodiments, the storage capacitor C_{ST} may be omitted.

The switching element Q including a TFT is provided on the lower panel 100 and has three terminals: a control terminal connected to one of the gate lines G₁-G₂ₙ; an input terminal connected to one of the data lines D₁-Dₘ; and an output terminal connected to both the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as the dielectric of the LC capacitor C_{LC}. The pixel electrode 190 is connected to the switching element Q, and the common electrode 270 is supplied with a common voltage Vcom and covers an entire surface of the upper panel 200. In other embodiments, the common electrode 270 may be provided on the lower panel 100, and at least one of the electrodes 190 and 270 may have a shape of bar or stripe.

The storage capacitor C_{ST} is an auxiliary capacitor for the LC capacitor C_{LC}. The storage capacitor C_{ST} includes the pixel electrode 190 and a separate signal line, which is provided on the lower panel 100, overlaps the pixel electrode 190 via an insulator, and is supplied with a predetermined voltage such as the common voltage Vcom. Alternatively, the storage capacitor C_{ST} can include the pixel electrode 190 and an adjacent gate line referred to as a previous gate line, which overlaps the pixel electrode 190 via an insulator.

For color display, each pixel PX uniquely represents one of primary colors (i.e., spatial division) or each pixel PX sequentially represents the primary colors in turn (i.e., temporal division) such that spatial or temporal sum of the primary colors are recognized as a desired color. FIG. 2 shows an example of the spatial division that each pixel PX includes a color filter 230 representing one of the primary colors in an area of the upper panel 200 facing the pixel electrode 190. Alternatively, the color filter 230 is provided on or under the pixel electrode 190 on the lower panel 100.

An example of a set of the primary colors includes red, green, and blue colors. The pixels PX including red, green, and blue color filters are referred to as red, green, and blue pixels, respectively.

One or more polarizers (not shown) are attached to at least one of the panels 100 and 200. In addition, one or more retardation films (not shown) for compensating refractive anisotropy may be disposed between the polarizer(s) and the panel(s).

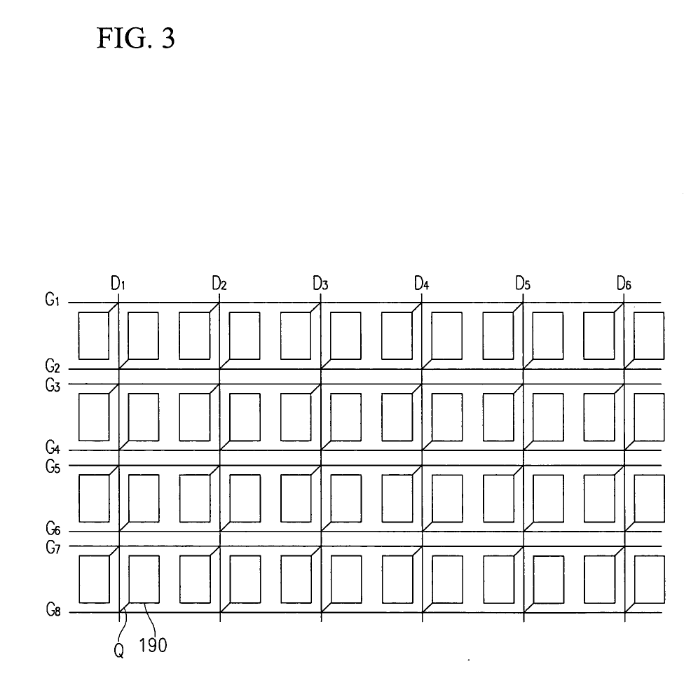

Referring to FIG. 3, an arrangement of the gate lines, the data lines, and the pixels according to an embodiment of the present invention is described in detail. FIG. 3 is an abstract representation of the pixel matrix with the switching element Q represented by a line at the corner of the pixel electrode connecting the pixel electrode to a respective gate line and a respective data line.

FIG. 3 illustrates an arrangement of the pixels and the signal lines according to an embodiment of the present invention.

As shown in FIG. 3, each pair of gate lines G₂ᵢ₋₁ and G₂ᵢ(i=1, 2, . . . , n) are disposed at the upper and lower sides of a row of pixel electrodes 190 such that the gate lines G₂ᵢ₋₁ and G₂ᵢ are connected thereto through TFTs Q. Each data line Dⱼ(j=1, 2, 3, . . . ) is disposed between two adjacent columns of the pixel electrodes 190 and connected to pixel electrodes 190 at the right side and the left side of the data line through the TFTs Q. In other words, each data line Dⱼ(j=1, 2, 3, . . . ) is disposed between adjacent pairs of pixel electrodes 190.

In other words, pixel electrodes 190 in a row are connected to the data lines D₁-Dₘ and alternately connected to a pair of gate lines G₂ᵢ₋₁ and G₂ᵢ adjacent to the row of pixel electrodes. Pixel electrodes 190 in a column are connected to a data line Dⱼ nearest the column and connected to respective ones of the gate lines G₁ to G₂ₙ. For example, in a pair of pixel electrodes 190 which are disposed opposite each other with respect to a data line D₁, D₂, D₃, . . . and connected to the data line D₁, D₂, D₃, . . . , the pixel electrode 190 on the left side of the pair is connected to an upper gate line G₁, G₃, G₅, . . . and the pixel electrode 190 on the right side of the pair is connected to a lower gate line G₂, G₄, G₆, . . . . In other words, the (2k−1)th pixel (k=1, 2, . . . , m/2) in each pixel row is connected to the (2i−1)th gate line G₂ᵢ₋₁ and the k-th data line Dₖ and the 2k-th pixel is connected to the 2i-th gate line G₂ᵢ and the k-th data line Dₖ.

This arrangement reduces the number of the data lines D₁, D₂, D₃, . . . into half of the pixel columns.

A lower panel of an LC panel assembly according to an embodiment of the present invention will be described in detail with reference to FIGS. 4-6 and FIG. 2.

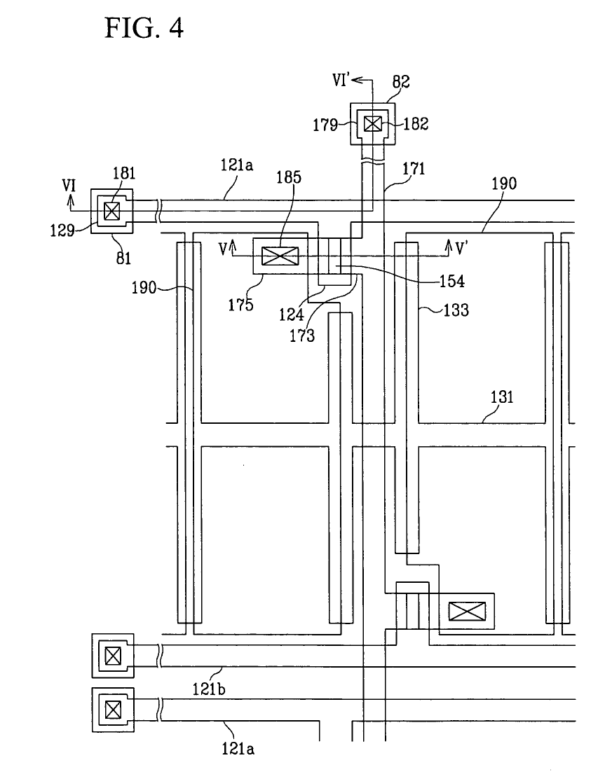

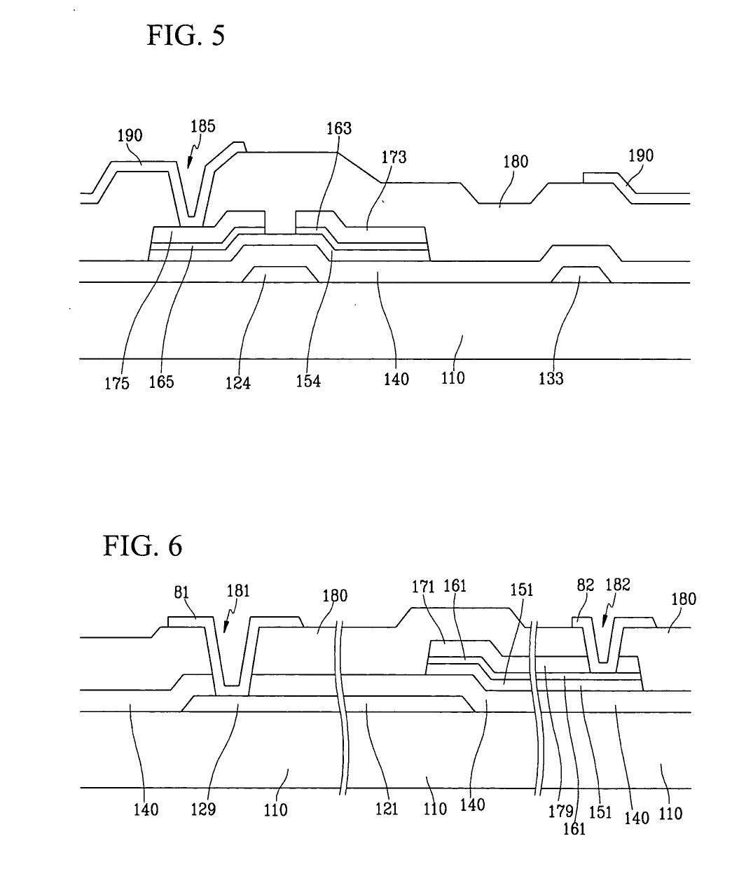

FIG. 4 is a layout view of a lower panel according to an embodiment of the present invention and FIGS. 5 and 6 are sectional views of the lower panel shown in FIG. 4 taken along the lines V-V′ and VI-VI′, respectively.

A plurality of pairs of gate lines 121a and 121b and a plurality of storage electrode lines 131 are formed on an insulating substrate 110 such as transparent glass.

The gate lines 121a and 121b extend substantially in a transverse direction to transmit gate signals and they are separated from each other. A pair of gate lines 121a and 121b include a plurality of gate electrodes 124 projecting toward each other, i.e., upward and downward. Each gate line 121a or 121b further includes an end portion 129 having a large area for contact with another layer or a driving circuit. The gate lines 121a and 121b may extend to be connected to a driving circuit that may be integrated on the lower panel 100.

Each storage electrode line 131 extends substantially in the transverse direction and is substantially equidistant from a pair of gate lines 121a and 121b. Each storage electrode line 131 includes a plurality of pairs of storage electrodes 133 extending in a longitudinal direction. The storage electrode lines 131 are supplied with a predetermined voltage such as a common voltage, which is applied to a common electrode 270 on the common electrode panel 200 of the LCD. Each storage electrode line 131 may include a pair of stems extending in the transverse direction and may have various shapes.

The gate lines 121a and 121b and the storage electrode lines 131 are preferably made of Al containing metal such as Al and Al alloy, Ag containing metal such as Ag and Ag alloy, Cu containing metal such as Cu and Cu alloy, Mo containing metal such as Mo and Mo alloy, Cr, Ti or Ta. The gate lines 121a and 121b and the storage electrode lines 131 may have a multi-layered structure including two films having different physical characteristics. One of the two films is preferably made of low resistivity metal including Al containing metal, Ag containing metal, and Cu containing metal for reducing signal delay or voltage drop in the gate lines 121a and 121b and the storage electrode lines 131. The other film is preferably made of material such as Mo containing metal, Cr, Ta or Ti, which has good physical, chemical, and electrical contact characteristics with other materials such as indium tin oxide (ITO) or indium zinc oxide (IZO). Good examples of the combination of the two films are a lower Cr film and an upper Al (alloy) film and a lower Al (alloy) film and an upper Mo (alloy) film. However, they may be made of various metals or conductors.

The lateral sides of the gate lines 121a and 121b and the storage electrode lines 131 are inclined relative to a surface of the substrate, and the inclination angle thereof ranges about 20-80 degrees.

A gate insulating layer 140 preferably made of silicon nitride (SiNx) is formed on the gate lines 121a and 121b and the storage electrode lines 131.

A plurality of semiconductor stripes 151 preferably made of hydrogenated amorphous silicon (abbreviated to “a-Si”) or polysilicon are formed on the gate insulating layer 140. Each semiconductor stripe 151 extends substantially in the longitudinal direction and has a plurality of projections 154 branched out toward the gate electrodes 124.

A plurality of ohmic contact stripes and islands 161 and 165 preferably made of silicide or n+ hydrogenated a-Si heavily doped with n type impurity such as phosphorous are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are inclined relative to a surface of the substrate, and the inclination angles thereof are preferably in a range of about 30-80 degrees.

A plurality of data lines 171 and a plurality of drain electrodes 175 separated from the data lines 171 are formed on the ohmic contacts 161 and 165.

The data lines 171 extend substantially in the longitudinal direction to transmit data voltages and intersect the gate lines 121a and 121b and the storage electrode lines 131 such that each data line 171 passes between adjacent two pairs of the storage electrodes 133. Each data line 171 includes an end portion 179 having a large area for contact with another layer or an external device and a plurality of source electrodes 173 projecting toward the drain electrodes 175.

Each pair of source and drain electrodes 173 and 175 are disposed opposite each other with respect to a gate line 124. A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The data lines 171 and the drain electrodes 175 are preferably made of refractory metal such as Cr, Mo, Ti, Ta or alloys thereof. However, they may have a multilayered structure including a low-resistivity film (not shown) and a good-contact film (not shown). Good example of the multi-layered structure are a double-layered structure including a lower Cr film and an upper Al (alloy) film, a double-layered structure of a lower Mo (alloy) film and an upper Al (alloy) film, and a triple-layered of a lower Mo film, an intermediate Al film, and an upper Mo film.

Like the gate lines 121a and 121b and the storage electrode lines 131, the data lines 171 and the drain electrodes 175 have inclined edge profiles, and the inclination angles thereof range about 30-80 degrees.

The ohmic contacts 161 and 165 are interposed only between the underlying semiconductor stripes 151 and the overlying conductors 171 and 175 thereon and reduce the contact resistance therebetween. The semiconductor stripes 151 have almost the same planar shapes as the data lines 171 and the drain electrodes 175 as well as the underlying ohmic contacts 161 and 165. However, the projections 154 of the semiconductor stripes 151 include some exposed portions, which are not covered with the data lines 171 and the drain electrodes 175, such as portions located between the source electrodes 173 and the drain electrodes 175. Alternatively, only the projections 154 may be remained without other portions of the semiconductor stripes 151.

A passivation layer 180 is formed on the data lines 171 and the drain electrodes 175, and the exposed portions of the semiconductor stripes 151. The passivation layer 180 is preferably made of inorganic insulator such as silicon nitride or silicon oxide, photosensitive organic material having a good flatness characteristic, or low dielectric insulating material that have dielectric constant lower than 4.0 such as a-Si:C:O and a-Si:O:F formed by plasma enhanced chemical vapor deposition (PECVD). The passivation layer 180 may have a double-layered structure including a lower inorganic film and an upper organic film so that it may take the advantage of the organic film as well as it may protect the exposed portions of the semiconductor stripes 151.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121.

A plurality of pixel electrodes 190 and a plurality of contact assistants 81 and 82, which are preferably made of transparent conductor such as ITO or IZO or reflective conductor such as Ag or Al, are formed on the passivation layer 180.

The pixel electrodes 190 are physically and electrically connected to the drain electrodes 175 through the contact holes 185 such that the pixel electrodes 190 receive the data voltages from the drain electrodes 175. The pixel electrodes 190 supplied with the data voltages generate electric fields in cooperation with the common electrode 270 supplied with the common voltage, which determine the orientations of liquid crystal molecules in the liquid crystal layer 3.

As described above, a pixel electrode 190 and a common electrode 270 form a liquid crystal capacitor C_{LC}, which stores applied voltages after the TFT turns off. A storage capacitor C_{ST}, which is connected in parallel to the liquid crystal capacitor C_{LC} for enhancing the voltage storing capacity, is implemented by overlapping the pixel electrode 190 with a storage electrode line 131 including the storage electrodes 133.

The pixel electrodes 190 have longitudinal edges disposed on the storage electrodes 133 so that the storage electrodes 133 block the interference between the pixel electrodes 190 and the data lines 171 and the interference between the pixel electrodes 190.

The contact assistants 81 and 82 are connected to and cover the end portions 121 of the gate lines 121 and the end portions 179 of the data lines 171 through the contact holes 181 and 182, respectively. The contact assistants 81 and 82 protect the end portions 129 and 179 and complement the adhesion of the end portions 129 and 179 and external devices.

An alignment layer (not shown) for initially aligning the LC molecules is coated on the pixel electrodes 190 and the passivation layer 180.

Referring to FIG. 1 again, the gray voltage generator 800 generates two sets of a plurality of gray voltages related to the transmittance of the pixels. The gray voltages in one set have a positive polarity with respect to the common voltage Vcom, while those in the other set have a negative polarity with respect to the common voltage Vcom.

The gate driver 400 is connected to the gate lines G₁-G₂ₙ of the panel assembly 300 and synthesizes the gate-on voltage Von and the gate-off voltage Voff from an external device to generate gate signals for application to the gate lines G₁-G₂ₙ.

The data driver 500 is connected to the data lines D₁-Dₘ of the panel assembly 300 and applies data voltages, which are selected from the gray voltages supplied from the gray voltage generator 800, to the data lines D₁-Dₘ.

The drivers 400 and 500 may include at least one integrated circuit (IC) chip mounted on the panel assembly 300 or on a flexible printed circuit (FPC) film in a tape carrier package (TCP) type, which are attached to the LC panel assembly 300. Alternately, the drivers 400 and 500 may be integrated into the panel assembly 300 along with the display signal lines G₁-G₂ₙ and D₁-Dₘ and the TFT switching elements Q.

The signal controller 600 controls the gate driver 400 and the gate driver 500.

Now, the operation of the above-described LCD will be described in detail.

The signal controller 600 is supplied with input image signals R, G and B and input control signals controlling the display thereof such as a vertical synchronization signal Vsync, a horizontal synchronization signal Hsync, a main clock MCLK, and a data enable signal DE, from an external graphics controller (not shown). After generating gate control signals CONT1 and data control signals CONT2 and processing the image signals R, G and B suitable for the operation of the panel assembly 300 on the basis of the input control signals and the input image signals R, G and B, the signal controller 600 transmits the gate control signals CONT1 to the gate driver 400, and the processed image signals DAT and the data control signals CONT2 to the data driver 500. The processing of the image signals R, G and B includes the rearrangement of the image data R, G and B according to the pixel arrangement of the panel assembly 300 shown in FIG. 3.

The gate control signals CONT1 include a scanning start signal STV for instructing to start scanning and at least a clock signal for controlling the output time of the gate-on voltage Von. The gate control signals CONT1 may further include an output enable signal OE for defining the duration of the gate-on voltage Von.

The data control signals CONT2 include a horizontal synchronization start signal STH for informing of start of data transmission for a group of pixels, a load signal LOAD for instructing to apply the data voltages to the data lines D₁-Dₘ, and a data clock signal HCLK. The data control signal CONT2 may further include an inversion signal RVS for reversing the polarity of the data voltages (with respect to the common voltage Vcom).

Responsive to the data control signals CONT2 from the signal controller 600, the data driver 500 receives a packet of the image data DAT for half of a row of pixels from the signal controller 600, converts the image data DAT into analog data voltages selected from the gray voltages supplied from the gray voltage generator 800, and applies the data voltages to the data lines D₁-Dₘ.

The gate driver 400 applies the gate-on voltage Von to the gate line G₁-G₂ₙ in response to the gate control signals CONT1 from the signal controller 600, thereby turning on the switching elements Q connected thereto. The data voltages applied to the data lines D₁-Dₘ are supplied to the pixels through the activated switching elements Q.

The difference between the data voltage and the common voltage Vcom is represented as a voltage across the LC capacitor C_{LC}, which is referred to as a pixel voltage. The LC molecules in the LC capacitor C_{LC} have orientations depending on the magnitude of the pixel voltage, and the molecular orientations determine the polarization of light passing through the LC layer 3. The polarizer(s) converts the light polarization into the light transmittance.

By repeating this procedure by a unit of half of a horizontal period (which is denoted by “½ H” and equal to half period of the horizontal synchronization signal Hsync or the data enable signal DE, all gate lines G₁-G₂ₙ are sequentially supplied with the gate-on voltage Von during a frame, thereby applying the data voltages to all pixels. When the next frame starts after one frame finishes, the inversion control signal RVS applied to the data driver 500 is controlled such that the polarity of the data voltages is reversed (which is referred to as “frame inversion”). The inversion control signal RVS may be also controlled such that the polarity of the data voltages flowing in a data line in one frame are reversed (for example, line inversion and dot inversion), or the polarity of the data voltages in one packet are reversed (for example, column inversion and dot inversion).

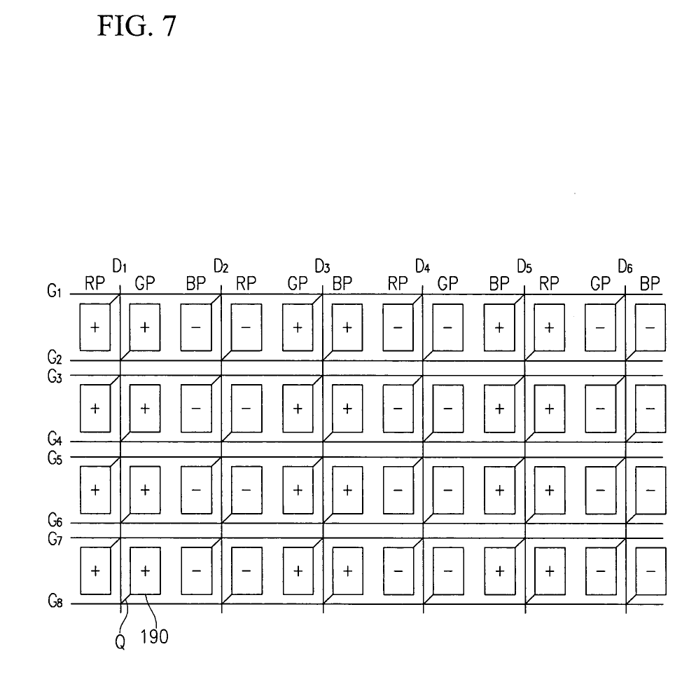

Now, a column inversion according to an embodiment of the present invention will be described in detail with reference to FIG. 7.

FIG. 7 shows polarity of the pixel voltages of the pixels having the arrangement shown in FIG. 3 under column inversion.

First, the arrangement of the pixels will be described more in detail.

Red, green, and blue pixels denoted by RP, GP and BP, respectively, are arranged in a matrix having rows and columns. Each pixel row includes red, green and blue pixels RP, GP and BP arranged in sequence and the pixels in each pixel column represent only one color, which is referred to as a stripe arrangement.

In the column inversion shown in FIG. 7, the pixel voltages of the pixels connected to a data line D₁, D₃, D₅, . . . have the same polarity, while the pixel voltages of the pixels connected to adjacent data lines D₂, D₄, D₆, . . . have opposite polarities.

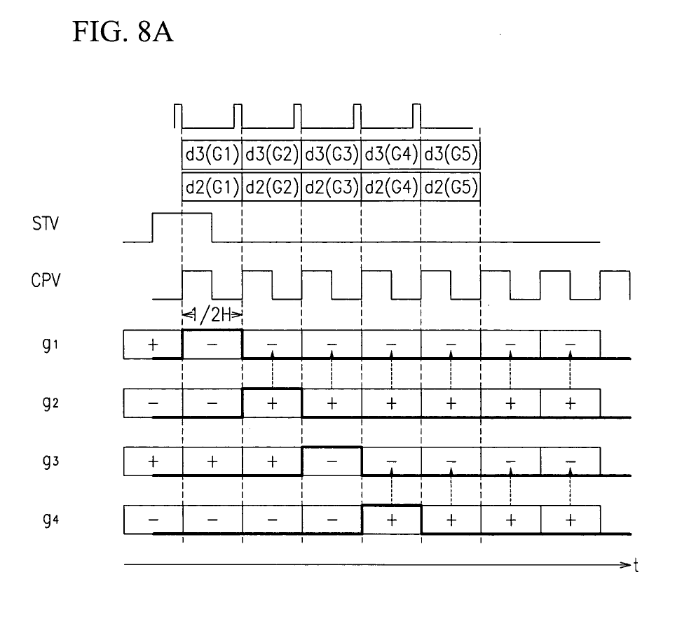

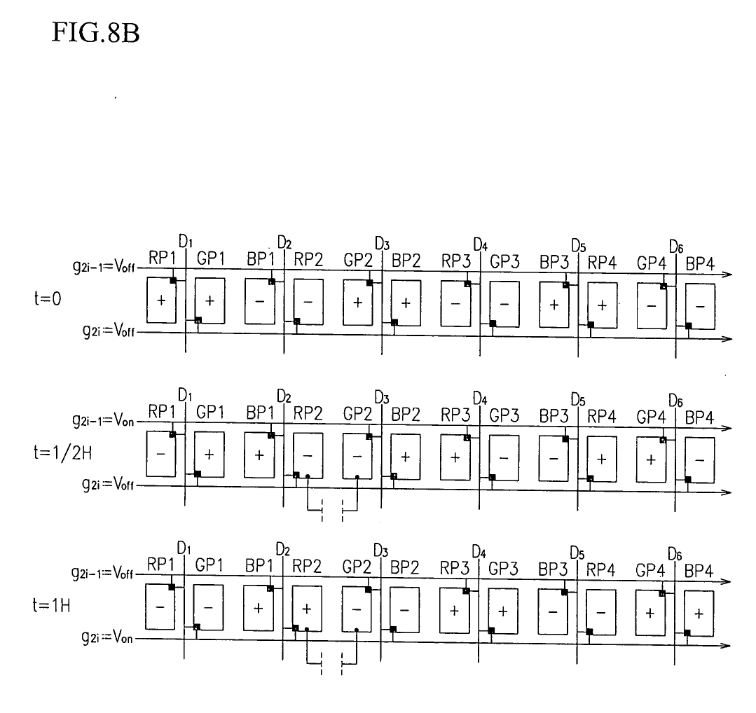

Next, several methods of applying data voltages to the pixels according to embodiments of the present invention will be described in detail with reference to FIGS. 8A-11B.

FIGS. 8A, 9A, 10A and 11A illustrate signal waveforms of LCDs according to embodiments of the present invention and FIGS. 8B, 9B, 10B and 11B illustrate polarity of the pixel voltages of a pixel row in the LCDs shown in FIGS. 8A, 9A, 10A and 11A as a function of time, respectively.

In FIGS. 8A-11B, gj(j=1, 2, . . . ) denotes the gate signal applied to the j-th gate line Gⱼ and d2 and d3 denote the data voltages applied to the second and the third data lines D₂ and D₃ shown in FIG. 7. In FIGS. 8A, 9A, 10A and 11A, the sign (+) and (−) written in the gate signals g1, g3, . . . denote the polarity of the pixels connected to an upper gate line or an odd gate line G₂ᵢ₋₁ and the third data line D₃, and the sign (+) and (−) written in the gate signals g2, g4, . . . denote the polarity of the pixels connected to a lower gate line or an even gate line G₂ᵢ and the second data line D₂.

Referring to FIGS. 8A and 8B, the duration of the gate-on voltage Von applied to each gate line G₁-G₂ₙ is equal to ½ H, i.e., one period of a gate clock signal CPV, which is a kind of clock signal supplied to the gate driver 400.

As shown in FIG. 8B, the polarity of the pixel voltage changes every two pixels at a time t=0, i.e., at initial time when the upper gate line G₂ᵢ₋₁ and the lower gate line G₂ᵢ are not supplied with the gate-on voltage Von yet.

At t=½ H, when the upper gate line G₂ᵢ₋₁ is supplied with the gate-on voltage Von, the pixels connected to the upper gate line G₂ᵢ₋₁ are supplied with the data voltages and thus the polarity of the pixel voltages is changed. At this time, two adjacent pixels without interposed data line have the same polarity, and the parasitic coupling capacitance between the two pixels determines the final value of the pixel voltages of the pixels connected to the upper gate line G₂ᵢ₋₁.

At t=1 H, when the upper gate line G₂ᵢ₋₁ is supplied with the gate-off voltage Voff and the lower gate line G₂ᵢ is supplied with the gate-on voltage Von, the polarity of the pixel voltages of the pixels connected to the lower gate line G₂ᵢ changes. At this time, two directly adjacent pixels have opposite polarities, and the parasitic coupling capacitance between the two pixels changes the final value of the pixel voltages of the pixels conned to the upper gate line G₂ᵢ₋₁. In the present description, two “directly adjacent” pixels refer to two adjacent pixels that have no data line interposing between the pixels.

In the meantime, among the pixels representing a given color, some pixels are connected to the upper gate line G₂ᵢ₋₁, while the other pixels representing the same color are connected to the lower gate line G₂ᵢ. For example, in FIG. 8b, a green pixel GP1 in the first green pixel column is connected to the lower gate line G₂ᵢ, while another green pixel in the second green pixel column is connected to the upper gate line G₂ᵢ₋₁.

By the way, a pixel connected to the upper gate line G₂ᵢ₋₁ changes its pixel voltage due to the parasitic capacitance when a pixel connected to the lower gate line G₂ᵢ is charged. However, the pixel voltage of the pixel connected to the lower gate line G₂ᵢ is not changed during the charging of the pixel connected to the upper gate line G₂ᵢ₋₁. Accordingly, the actual pixel voltage of the pixels connected to the upper gate line G₂ᵢ₋₁ is different from that of the pixels connected to the lower gate line G₂ᵢ even though they are supplied with the same voltage.

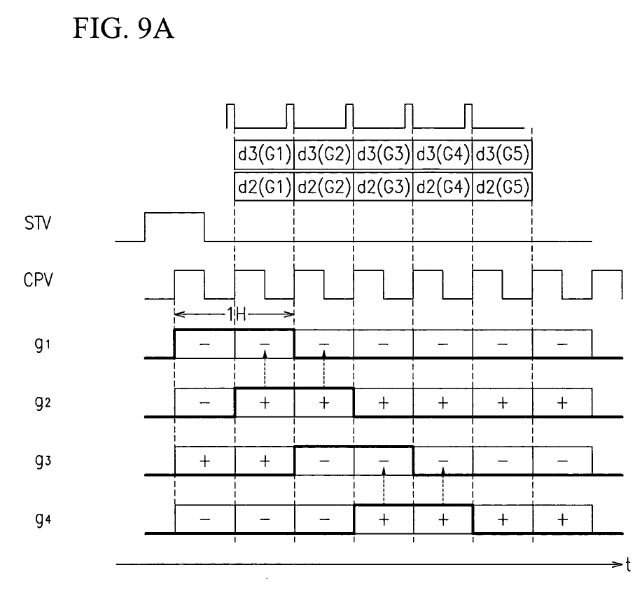

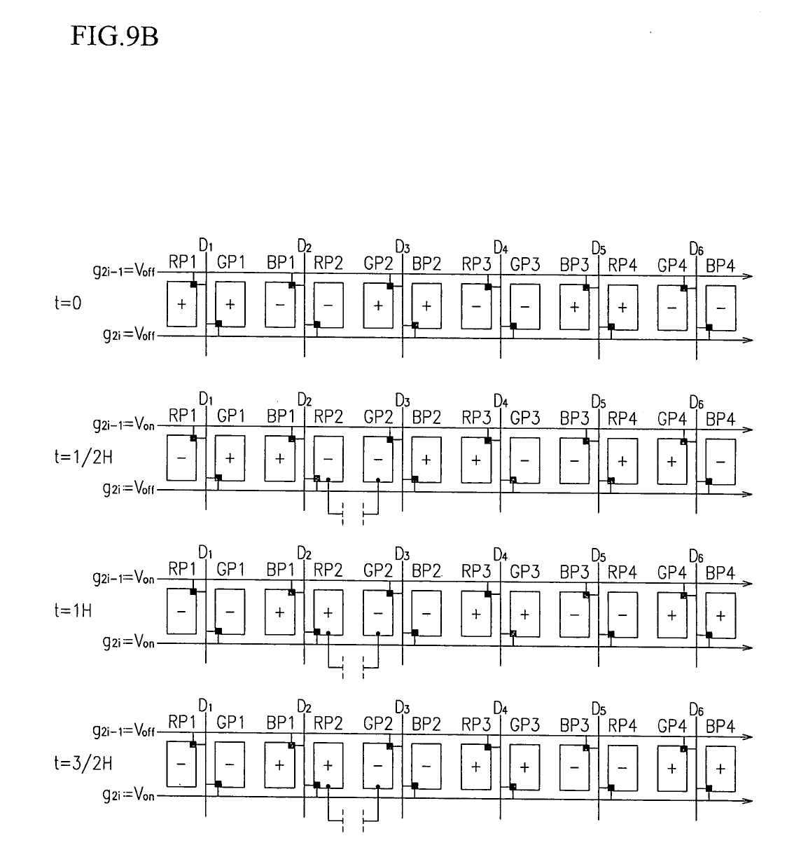

Referring to FIGS. 9A and 9B, the duration of the gate-on voltage Von applied to each gate line G₁-G₂ₙ is equal to 1 H and the durations of the gate-on voltage Von applied to adjacent gate lines G₁-G₂ₙ overlap each other for ½ H. At this time, a target data voltage for each pixel is applied to the pixel during the latter half of 1 H.

At t=½ H, as shown in FIG. 9B, when the upper gate line G₂ᵢ₋₁ is supplied with the gate-on voltage Von, the pixels connected to the upper gate line G₂ᵢ₋₁ are supplied with the data voltages for the pixels connected to the previous gate line G₂ᵢ₋₂. Therefore, the polarity of the pixel voltages is inverted.

At t=1 H, the upper gate line G₂ᵢ₋₁ is still supplied with the gate-on voltage Von and the lower gate line G₂ᵢ is supplied with the gate-on voltage Von. At this time, the data voltages for the pixels connected to the upper gate line G₂ᵢ₋₁ are supplied to all the pixels connected to the upper and the lower gate lines G₂ᵢ₋₁ and G₂ᵢ. Since the pixels connected to the upper gate line G₂ᵢ₋₁ are already charged with a voltage having the same polarity, the polarity of the pixel voltages thereof is not changed. However, the pixels connected to the lower gate line G₂ᵢ experience the polarity inversion of the pixel voltages. Therefore, two pixels directly adjacent each other have opposite polarities and the parasitic capacitance between the two pixels determine the final value of the pixel voltages of the pixels connected to the upper gate line G₂ᵢ₋₁.

At t= 3/2 H, when the upper gate line G₂ᵢ₋₁ is supplied with the gate-off voltage Voff and the lower gate line G₂ᵢ is supplied with the gate-on voltage Von, the data voltages for the pixels connected to the lower gate line G₂ᵢ are applied to the data lines D₁-Dₘ and the polarity of the pixel voltages of the pixels, which are connected to the lower gate line G₂ᵢ and precharged with a voltage, is maintained. Since two pixels directly adjacent to each other still have opposite polarities, the variation of the pixel voltages of the pixels connected to the upper gate line G₂ᵢ₋₁ due to the parasitic capacitance is very small.

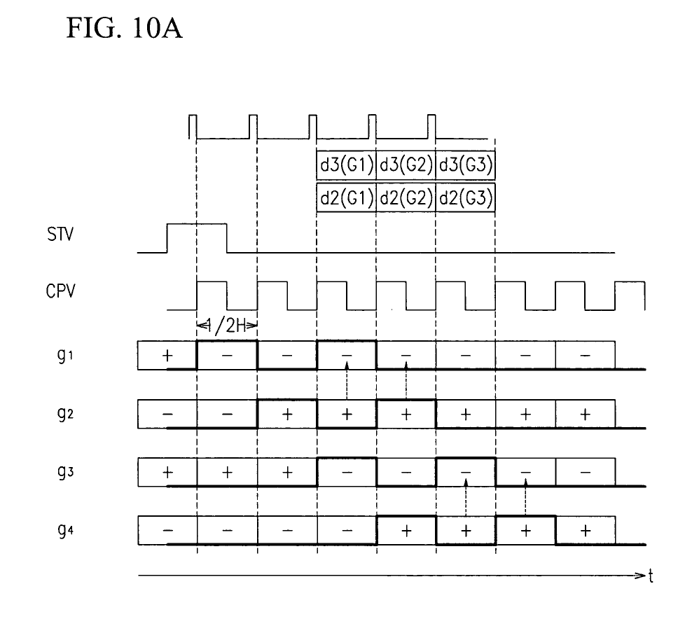

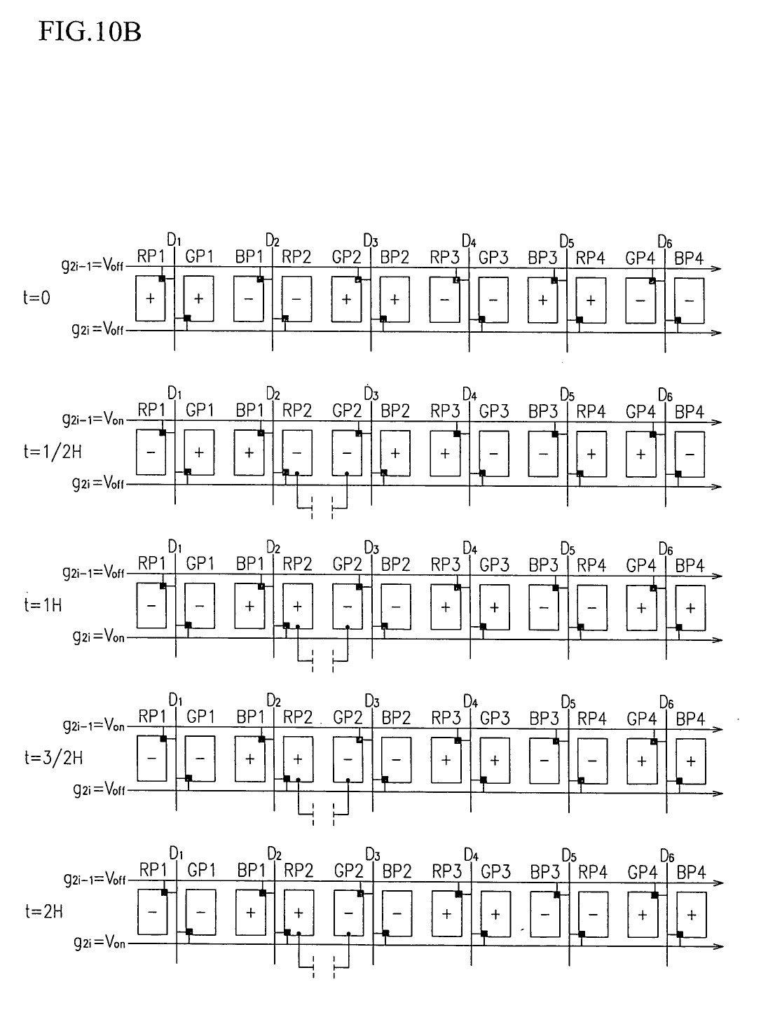

Referring to FIGS. 10A and 10B, each gate line G₁-G₂ₙ is supplied with the gate-on voltage Von for ½ H twice in a time interval of ½ H and each pixel is supplied with its own data voltage during the second application of the gate-on voltage Von.

At t=½ H, as shown in FIG. 10B, when the upper gate line G₂ᵢ₋₁ is supplied with the gate-on voltage Von, the pixels connected to the upper gate line G₂ᵢ₋₁ are precharged with the data voltages for the pixels connected to the one before last gate line G₂ᵢ₋₃ and thus the polarity of pixel voltages thereof is changed.

At t=1 H, the upper gate line G₂ᵢ₋₁ is supplied with the gate-off voltage Voff and the lower gate line G₂ᵢ is supplied with the gate-on voltage Von. The pixels connected to the lower gate line G₂ᵢ are precharged with the data voltages for the pixels connected to the one before last gate line G₂ᵢ₋₂ and thus the polarity of pixel voltages thereof is changed.

At t= 3/2 H, the upper gate line G₂ᵢ₋₁ is supplied with the gate-on voltage Von again and the lower gate line G₂ᵢ is supplied with the gate-off voltage Voff. The pixels connected to the upper gate line G₂ᵢ₋₁ are supplied with their own data voltages. Since the pixels connected to the upper gate line G₂ᵢ₋₁ are precharged with a voltage having the same polarity, the polarity inversion does not occur. At this time, two pixels directly adjacent each other have opposite polarities and the parasitic capacitance between the two pixels determine the final value of the pixel voltages of the pixels connected to the upper gate line G₂ᵢ₋₁.

At t=2 H, when the upper gate line G₂ᵢ₋₁ is supplied with the gate-off voltage Voff and the lower gate line G₂ᵢ is supplied with the gate-on voltage Von, the pixels connected to the lower gate line G₂ᵢ are supplied with their own data voltages through the data lines D₁-Dₘ and the polarity inversion does not occur. Since two pixels directly adjacent to each other still have opposite polarities, the variation of the pixel voltages of the pixels connected to the upper gate line G₂ᵢ₋₁ due to the parasitic capacitance is very small.

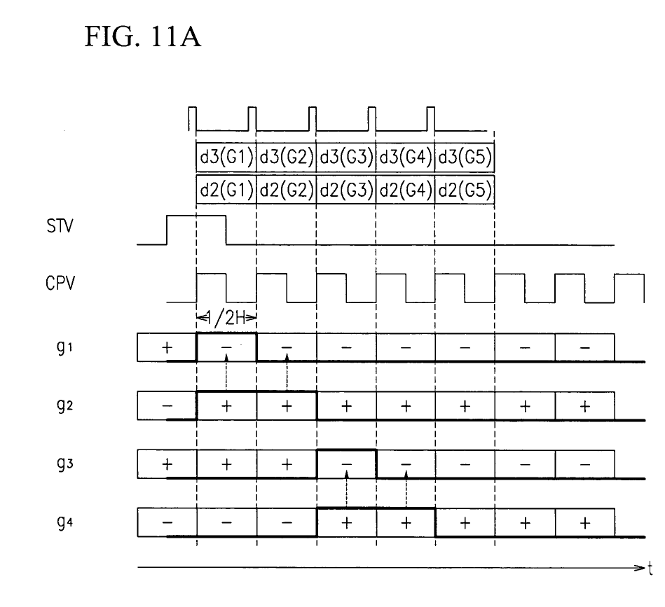

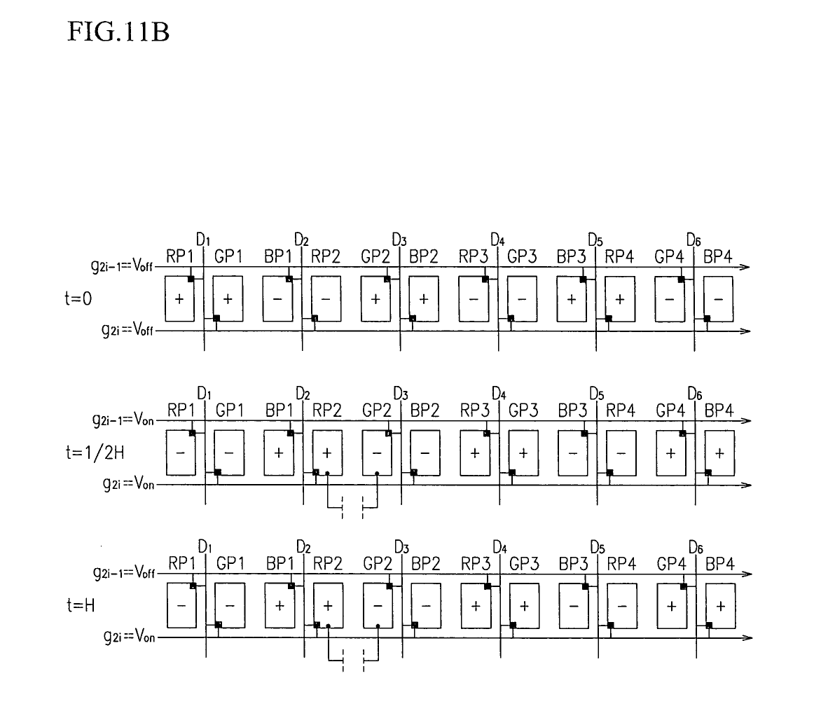

Referring to FIGS. 11A and 11B, the upper gate line G₁, G₃, . . . , G₂ᵢ₋₁, . . . are supplied with the gate-on voltage Von for ½ H and the lower gate line G₂, G₄, . . . , G₂ᵢ, . . . is supplied with the gate-on voltage Von for 1 H. The upper and the lower gate lines G₂ᵢ₋₁ and G₂ᵢ are simultaneously supplied with the gate-on voltage Von for ½ H. The pixels connected to the lower gate line G₂, G₄, . . . , G₂ᵢ, . . . are supplied with their own data voltages during the latter half of 1 H.

At t=½ H, as shown in FIG. 11B, when the upper and the lower gate lines G₂ᵢ₋₁ and G₂ᵢ is supplied with the gate-on voltage Von, all the pixels connected to the upper and the lower gate lines G₂ᵢ₋₁ are supplied with the data voltages for the pixels connected to the upper gate line G₂ᵢ₋₁. Therefore, both the pixels connected to the upper and the lower gate lines G₂ᵢ₋₁ experience the polarity inversion. At this time, two pixels directly adjacent each other have opposite polarities and the parasitic capacitance between the two pixels determnine the final value of the pixel voltages of the pixels connected to the upper gate line G₂ᵢ₋₁.

At t=1 H, the upper gate line G₂ᵢ₋₁ is supplied with the gate-off voltage Voff and the lower gate line G₂ᵢ is still supplied with the gate-on voltage Von. The pixels connected to the lower gate line G₂ᵢ are supplied with their own data voltages. Since the pixels connected to the lower gate line G₂ᵢ are already supplied with a voltage having the same polarity, there is no polarity inversion. Accordingly, since two pixels directly adjacent to each other still have opposite polarities, the variation of the pixel voltages of the pixels connected to the upper gate line G₂ᵢ₋₁ due to the parasitic capacitance is very small.

These driving schemes according to the embodiments of the present invention reduce the number of the data driving IC chips and ensure the image quality.

The present invention can be also employed to other display devices such as OLED.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

1. A display device comprising:
a plurality of pixel rows, each pixel row including a plurality of pairs of first and second pixels arranged in turn;
a plurality of first signal lines connected to the first pixels;
a plurality of second signal lines connected to the second pixels; and
a plurality of third signal lines intersecting the first and the second signal lines, each of the third signal lines disposed in between a pair of first and second pixels and connected to the pair of first and second pixels,
wherein the first and the second pixels are charged by voltages from the third signal lines in response to signals from the first and the second signal lines, respectively,
the charging of the first pixels in each pixel row is finished before the charging of the second pixels in the pixel row is finished,
the second pixels in each pixel row have a precharging time where charging voltages are applied before the charging of the first pixels in the pixel row is finished and a main charging time where charging voltages are applied after the charging of the first pixels in the pixel row is finished, and
the polarity of voltages charged into the second pixels during the precharging time is the same as the polarity of voltages charged into the second pixels during the main charging time.

2. The display device of claim 1, wherein adjacent third signal lines transmit voltages having opposite polarities.

3. The display device of claim 2, wherein the polarity of the voltages transmitted by each of the third signal lines is constant during a frame and is opposite between two adjacent frames.

4. The display device of claim 1, wherein the precharging time of the second pixels in each pixel row overlaps the charging time of the first pixels in the pixel row at least in part.

5. The display device of claim 4, wherein the first pixels in each pixel row have a precharging time overlapping the main charging time of the second pixels in a previous row and a main charging time for charging voltages after the main charging time of the second pixels in the previous row is finished, and the polarity of voltages charged into the first pixels during the precharging time thereof is the same as the polarity of voltages charged into the first pixels during the main charging time thereof.

6. The display device of claim 4, wherein the precharging time of the second pixels in each pixel row is equal to the charging time of the first pixels in the pixel row.

7. The display device of claim 1, wherein the precharging time of the second pixels in each pixel row is spaced apart from the charging time of the first pixels in the pixel row.

8. The display device of claim 7, wherein the first pixels in each pixel row have a precharging time that ends before the precharging time of the second pixels in the pixel row and a main charging time between the precharging time of the second pixels in the pixel row and the main charging time of the second pixels in the pixel row, and the polarity of voltages charged into the first pixels during the precharging time thereof is to the same as the polarity of voltages charged into the first pixels during the main charging time thereof.

9. A display device comprising:
a plurality of pixel rows, each pixel row including a plurality of pairs of first and second pixels arranged in turn;
a plurality of first signal lines connected to the first pixels;
a plurality of second signal lines connected to the second pixels; and
a plurality of third signal lines intersecting the first and the second signal lines, each of the third signal lines disposed in between a pair of first and second pixels and connected to the pair of first and second pixels,
wherein the first and the second pixels are charged by voltages from the third signal lines in response to signals from the first and the second signal lines, respectively,
and the charging time of the first pixels in each pixel row overlaps at least in part the charging time of the second pixels in the pixel row or the charging time of the first or the second pixels in another pixel row.

10. The display device of claim 9, wherein adjacent third signal lines transmit voltages having opposite polarities.

11. The display device of claim 10, wherein the polarity of the voltages transmitted by each of the third signal lines is constant during a frame and is opposite between two adjacent frames.

12. The display device of claim 9, wherein the charging time of the second pixels in each pixel row overlaps the charging time of the first pixels in the pixel row at least in part.

13. The display device of claim 12, wherein the first pixels in each pixel row begin the voltage charging before the second pixels in a previous pixel row finish the voltage charging and continue the voltage charging after the second pixels in the previous pixel row finish the voltage charging, and the second pixels in each pixel row begin the voltage charging before the first pixels in the pixel row finish the voltage charging and continue the voltage charging after the first pixels in the pixel row finish the voltage charging.

14. The display device of claim 12, wherein the second pixels in each pixel row starts the voltage charging in synchronization with the start of the voltage charging of the first pixels in the pixel row and continue after the completions of the voltage charging of the first pixels in the pixel row.

15. The display device of claim 9, wherein the charging time of the second pixels in each pixel row partly overlaps the charging time of the second pixels in a previous pixel row.

16. The display device of claim 15, wherein the charging time of the first pixels in each pixel row partly overlaps the charging time of the first pixels in a previous pixel row.

17. The display device of claim 16, wherein the charging time of the first pixels in each pixel row is spaced apart from the charging time of the second pixels in the pixel row.

18. A method of driving a display device including a plurality of first and the second pixels that are alternately arranged in a plurality of pixel rows, the method comprising:
charging first voltages in the first pixels;
charging second voltages into the second pixels before the charging of the first voltages is finished; and
charging third voltages having a polarity the same as the polarity of the second voltages into the second pixels after the charging of the first voltages is finished.

19. The method of claim 18, wherein the charging of the second voltages and the charging of the third voltages are sequentially performed.

20. The method of claim 19, further comprising:
charging the first pixels with fourth voltages having a polarity the same as the polarity of the first voltages before the charging of the first voltages and the charging of the second voltages.

21. The method of claim 20, wherein the charging of the fourth voltages and the charging of the first voltages are performed in sequence.

22. The method of claim 18, wherein the charging of the first voltages and the charging of the second voltages are simultaneously performed.

23. The method of claim 22, further comprising:
charging the first pixels with fourth voltages having a polarity the same as the polarity of the first voltages before the charging of the first voltages and the charging of the second voltages.

24. The method of claim 23, wherein the charging of the fourth voltages and the charging of the first voltages are performed in sequence.

25. The method of claim 18, wherein the charging of the second voltages is finished before the charging of the first voltages starts.

26. The method of claim 25, further comprising:
charging the first pixels with fourth voltages having a polarity the same as the polarity of the first voltages before the charging of the second voltages.

27. The method of claim 26, wherein the charging of the fourth voltages is finished before the charging of the second voltages starts.
